(19) United States
(12) Patent Application Publication
(10) Pub. No.: US 2023/0011878 A1
(43) Pub. Date: Jan. 12, 2023

(54) ROTATIONALLY TUNED FOOT PEG SYSTEM FOR A SADDLE VEHICLE

(71) Applicants: Dustin Briedwell, Bend, OR (US); Colin Tisdale, Bend, OR (US)

(72) Inventors: Dustin Briedwell, Bend, OR (US); Colin Tisdale, Bend, OR (US)

(21) Appl. No.: 17/858,958

(22) Filed: Jul. 6, 2022

Related U.S. Application Data
(60) Provisional application No. 63/219,353, filed on Jul. 7, 2021.

(51) Int. Cl. B62J 25/04

(52) U.S. Cl. CPC B62J 25/04

(57) ABSTRACT

A foot peg system for a saddle vehicle is provided. The foot peg system includes, in one example, a threaded spindle engaged with a frame mount and a foot platform rotationally coupled to the threaded spindle and including an upper side having a plurality of grip extensions. The foot peg system further includes an elastomeric stop positioned below a rotational axis of the threaded spindle adjacent to a lower side of the foot platform, coupled to the frame mount, and designed to constrain rotation of the foot platform.

### CROSS-REFERENCE TO RELATED APPLICATION

The present application claims priority to U.S. Provisional Application No. 63/219,353, entitled “ROTATIONALLY TUNED FOOT PEG SYSTEM FOR SADDLE VEHICLE”, and filed on Jul. 7, 2021. The entire contents of the above-listed application are hereby incorporated by reference for all purposes.

### TECHNICAL FIELD

The present disclosure relates generally to a foot peg system for a saddle vehicle.

### BACKGROUND AND SUMMARY

Two wheeled and other saddle type vehicles, such as motorcycles, commonly use foot pegs that serve as contact points for a rider's feet. Traditionally, the foot pegs are rigidly attached to a frame of the motorcycle via pins. The fixed orientation of these motorcycle foot pegs leads to a number of issues for the rider. Across motorcycle disciplines, changes in terrain can cause a rider to alter their stance. When the pegs have a fixed orientation, undue rider fatigue may result from the multitude of stance alterations that occur over the course of a ride. Loading of the ankle joint in a highly articulated position may be particularly pronounced in these scenarios and causes unwanted stress. The rider fatigue issues are exacerbated in off-road riding environments where riders commonly encounter greater variations in terrain, necessitating even greater rider movement compensation. Further, the grip between the rider's feet may diminish due to uneven terrain, resulting in degraded vehicle control.

U.S. Pat. No. 6,663,129 B1 to Smith discloses a spring loaded foot peg that attempts to resolve the abovementioned issues. In Smith's foot peg, a return spring attaches to a peg body that pivots about a foot peg shaft and constrains foot peg rotation. Smith's foot peg further includes a U-shaped mount with apertures that accept a pin for motorcycle frame attachment.

The inventors have identified a number of issues with Smith's foot peg and other prior peg designs. Smith's spring mechanism, for example, necessitates a convoluted system to retain the spring around the foot peg shaft. Replacing or servicing the foot peg system may consequently involve an arduous process that decreases the foot peg's adaptability. For instance, certain spring rates may more closely match a rider's preferences as well as riding conditions. However, because of the fixed spring rate in Smith's foot peg, the rotational support provided by the spring may not complement a rider's weight and/or their specific riding conditions. Thus, a mismatch between peg kinematics and a rider's weight, riding style, and/or terrain choice may occur, ultimately leading to excessive rider fatigue and diminished vehicle control. Previous foot pegs have been primarily constructed out of metal which may transfer unwanted vibrations from the vehicle frame to the rider's feet and may be susceptible to degradation from impacts. Metal pegs may also be costly to manufacture. Further, the contact patch on previous motorcycle pegs may not provide enough grip for the rider, in certain scenarios. Prior foot peg designs have therefore suffered from inadaptability and fallen short of providing desired levels of support, grip, and ergonomic characteristics to many riders.

To resolve at least a portion of the abovementioned problems with previous foot pegs, the inventors developed a foot peg system. The foot peg system, in one example, includes a threaded spindle engaged with a frame mount. The system additionally includes a foot platform rotationally coupled to the threaded spindle. The foot platform has an upper side with a plurality of grip extensions. The system further includes an elastomeric stop positioned below a rotational axis of the threaded spindle adjacent to a lower side of the foot platform. Further, the elastomeric stop is coupled to the frame mount and designed to constrain rotation of the foot platform. The elastomeric stop therefore permits the foot platform to rotate within a desired range while complementary providing a targeted degree of resistance to rotation to enhance rider comfort and reduce fatigue. For instance, the strain on the rider's ankle and lower body, more generally, may be decreased when the foot platform is permitted to rotate in this manner. Additionally, constraining platform rotation and providing a targeted amount of rotational damping allows the rider to maintain a desired degree of stability to execute shifting and braking operations.

In one example, the elastomeric stop may have an outer surface that is in face sharing contact with a surface on the lower side of the foot platform. In such an example, the outer surface may be rounded. Further in such an example, the elastomeric stop may be constructed out of polyurethane. Constructing the elastomeric stop in this manner allows the system to achieve a desired amount of foot platform dampening and resistance to rotation, further enhancing rider comfort.

The aforementioned summary above provides an abridged form of the concepts expanded upon in the detail description. The summary does not delineate the essential features of the claimed concepts. The claims presented after the detailed description solely bound the scope of the scope inventive concepts. The claimed concepts cover implementations that solve the aforementioned drawback of previous peg designs and/or other drawbacks of prior peg designs that are not explicitly mentioned.

### BRIEF DESCRIPTION OF THE DRAWINGS

FIG. 1 illustrates an exploded view of a first example foot peg system.

FIGS. 2-8 illustrate different views of the foot peg system, depicted in FIG. 1.

FIG. 9 illustrates an exploded view of a second example foot peg system.

FIGS. 10-18 illustrate different views of the foot peg system, depicted in FIG. 9.

FIG. 19 illustrates an example of an elastomeric stop.

### DETAILED DESCRIPTION

A highly adaptable foot peg system with far reaching applicability across numerous types of motorcycles and other saddle vehicles is described herein. The foot peg system includes an elastomeric stop designed to limit rotation of a foot platform within a desired range and provide a tuned amount of rotational resistance to a foot platform. This feature permits the rider's feet to maintain greater contact with the peg in a more ergonomic manner, thereby reducing rider fatigue, while at the same time permitting a high level of vehicle control. The system may be part of a kit that provides a high degree of adaptability to enable the system to better match a rider's preferences as well as the motorcycle's intended operating environment. For instance, a foot peg kit may be provided with multiple elastomeric stops that each constrain rotation of a foot platform but have varying amounts of compliance.

Furthermore, the components in the system may be constructed out of durable and comparatively low cost materials, when contrasted with previous foot pegs that are primarily manufactured from metal. For instance, the foot platform may be constructed out of a polymer such as an ultra-high-molecular-weight polyethylene (UHMWPE). For instance, the foot platform may be constructed out a polymer composite, such as a nylon composite, and the elastomeric stops may be constructed out of polyurethane. These materials may not only increase the durability of the foot peg but can also provide vibration dampening, further increasing rider comfort and decreasing fatigue. The UHMWPE may be manufactured via milling while the nylon composite may be manufactured using injection molding. However, numerous types of manufacturing techniques for the foot platform have been contemplated.

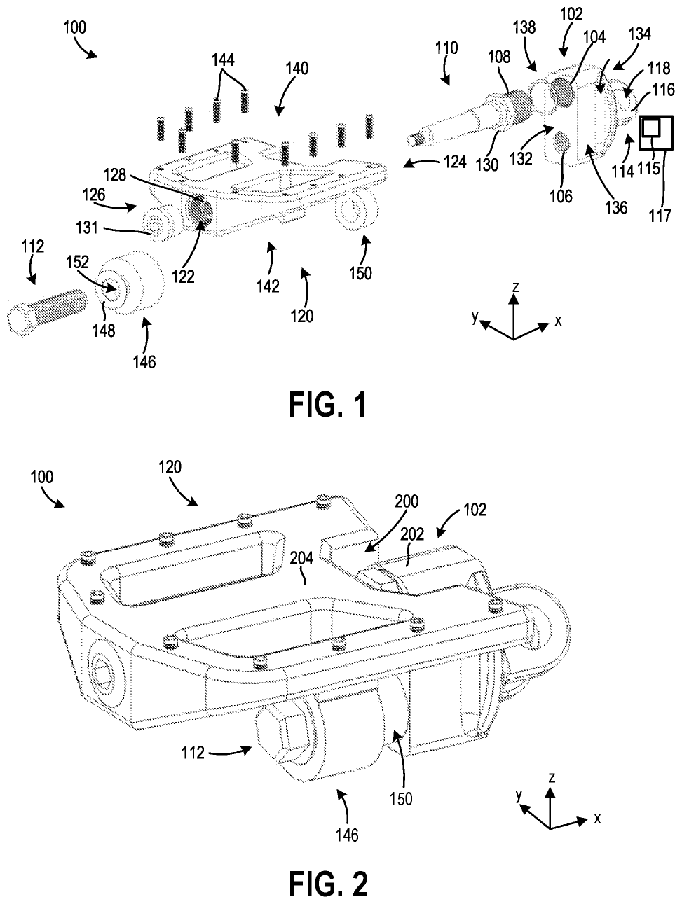

FIG. 1 shows an exploded view of a first example of a foot peg system 100 for a saddle vehicle 117 such as a motorcycle, snow bike, all-terrain vehicle (ATV), and the like. The system may therefore be used in both combustion engine vehicles and electric vehicles (EVs). Although, the foot peg system is shown with a single foot peg assembly, the system may include a second peg assembly for use on an opposite side of the vehicle and therefore may have a similar structure (e.g., a mirrored geometry).

The foot peg system 100 includes a frame mount 102 with a first threaded opening 104 and a second threaded opening 106. The first threaded opening 104 is contoured to threadingly engage with a threaded section 108 of a spindle 110 and the second threaded opening 106 is likewise contoured to threadingly engage with a stop mounting device 112, such as a bolt or other suitable attachment apparatus. The frame mount 102 may further include an attachment interface 114 profiled to attach to an interface 115 of a saddle vehicle 117 via a pin and/or other suitable attachment mechanism. The interface 115 may be included in a frame, in one example, and may therefore be referred to as a frame interface. However, in other examples, the interface 115 may be included in other comparatively rigid structures. Alternatively, the frame mount 102 may be welded or clamped to the vehicle.

The attachment interface 114, in one example, may be a U-shaped structure with two parallel extensions 116 that include openings 118. The openings 118 may be sized to accept pins for attachment to the vehicle. However, other suitable types of frame mounts have been contemplated such as clamps, threaded rods, combinations thereof, and the like. The second threaded opening 106 may be smaller than the first threaded opening 104, due to the variance in expected component loading. However, openings with different relative sizes have been contemplated. The attachment interface 114 may be angled to permit the foot peg assembly to be installed in a desired orientation on the vehicle. The angle of the attachment interface may be selected based on various factors such as the profile of the frame and the intended mounting location on the frame.

When assembled, the threaded spindle 110 rotatably attaches to a foot platform 120. To elaborate, the threaded spindle 110 may extend through a lateral opening 122 in the foot platform 120 that traverses the platform from an inboard side 124 to an outboard side 126. To facilitate this attachment, bearings (e.g., ball bearings, bushings, and the like) may be attached to a portion of the spindle 110 that extends away from the threaded section 108. A nut 128 may thread onto to a distal end of the spindle 110 and may be used to axially delimit foot platform movement in relation to the spindle. To permit efficient spindle installation and removal, the spindle may include a faceted portion 130 (e.g., a hexagonal section which enables the spindle to be rotated using conventional tools). Further, a cap 131 that may thread into and plug the lateral opening 122 may be provided in the system.

The frame mount 102 may include an outboard face 132 with the openings 104, 106, an inboard face 134 with the attachment interface 114, and two fore-aft faces 136, 138. The edges of the frame mount may be chamfered, in certain examples, to decrease the mount's profile and the chance of unwanted interaction with a rider's foot.

The foot platform 120 includes an upper side 140 and a lower side 142. Grip pins 144 may be coupled (e.g., removably coupled) to the foot platform 120. The grip pins permit the rider to achieve greater platform grip. When the grip pins are removably coupled to the platform, the pins may be quickly and efficiently swapped out with pins which have a different profile so as to vary the grip and more aptly match a rider's predilections.

The system 100 further includes an elastomeric stop 146 that is coupled (e.g., fixedly and non-rotatably coupled) to the frame mount 102. The attachment between the elastomeric stop 146 and the frame mount 102 may be achieved via the stop mounting device 112, washers 148, and/or spacer 150. When assembled, the mounting device 112 extends through an opening 152 in the elastomeric stop 146 and threads into the opening 106 in the frame mount 102. Compression of the elastomeric stop 146 by the mounting device 112 may impede its rotation. Additionally or alternatively, the elastomeric stop 146 and the mounting device 112 may include planar surfaces with square, rectangular, hexagonal, oval, etc., cross-sections that mate with one another and prevent rotation of the stop.

The elastomeric stop 146 may have a cylindrical shape, in one example. Alternatively, the elastomeric stop 146 may have an elliptical shape, at least one planar outer section, and/or a concave outer section. The profile of the elastomeric stop may be selected to achieve a desired degree of rotational damping of the foot platform 120 and may also constrain the rotation of the foot platform. Specifically, when assembled, the lower side 142 of the foot platform 120 is designed to interact with the elastomeric stop 146 to bound the rotation of the foot platform within a targeted range as well as provide some rotational damping. The amount of rotation permitted by the elastomeric stop may be ±45 degrees or less from the neutral position. Specifically, in some use-case examples, the amount of rotation permitted by the elastomeric stop may be ±30 degrees, ±20 degrees, ±15 degrees, or ±10 degrees. The range of foot platform rotation may be selected based on the type of saddle vehicle intended for use with the peg, the intended riding environment of the vehicle, and/or consumer predilections. The range of platform rotation and rotational damping provided by the elastomeric stop allows for a reduction in joint loading and unwanted amounts of ankle articulation while at the same time gives the rider the ability to efficiently balance and maneuver the vehicle as well as perform shifting and braking operations. In this way, rider fatigue may be reduced without diminishing the rider's ability to control the vehicle.

The frame mount 102 may be constructed out of one or more suitable metals such as steel, aluminum, titanium, and the like. The spindle 110 may also be constructed out of a metal such as steel, titanium, or aluminum. The foot platform 120 may be manufactured from a polymer such as a nylon composite, UHMWPE, and the like which is durable and may have a strength to weight ratio which may be on par with certain metal constructions. The polymer platform construction may further provide greater damping of road vibrations and impact resistance when compared to foot platforms constructed out of metal. Metal foot platforms may be used in some embodiments, which may however be costlier to manufacture and provide less vibration damping than the polymer construction.

The elastomeric stop 146 may be manufactured from polyurethane, in one example. The compliance of the polyurethane may vary based on the preference of the rider, rider weight, and intended riding environment. For instance, when the system is adapted for use in a street motorcycle, a harder elastomeric stop may be used. Conversely, when the system is adapted for use in an off-road motorcycle, a more compliant stop may be deployed.

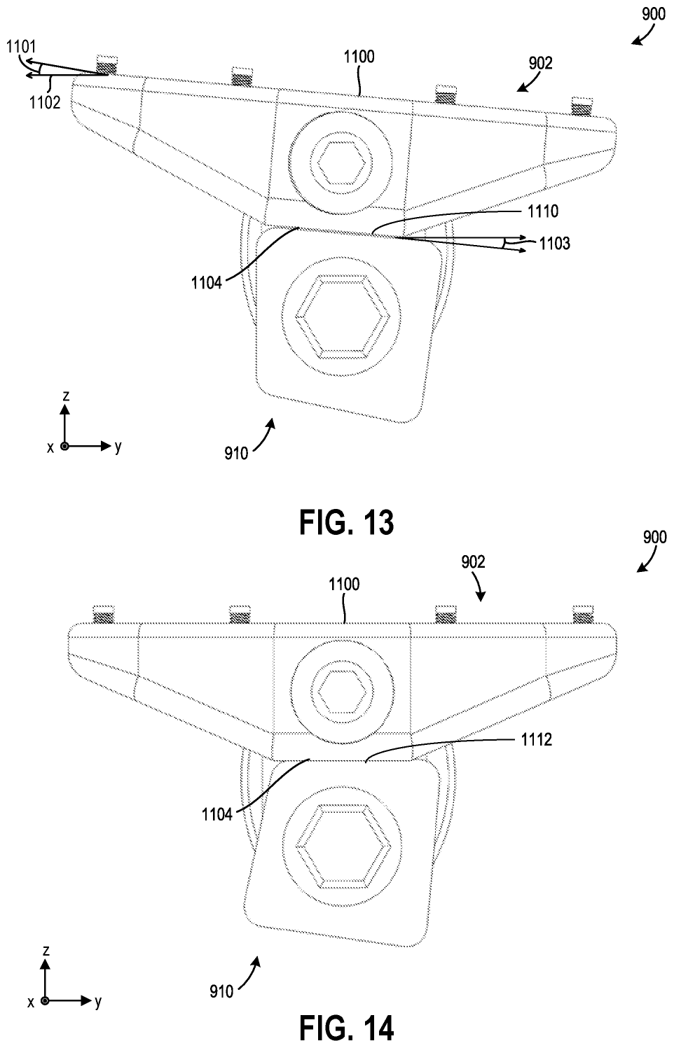

An axis system is provided in FIG. 1 as well as FIGS. 2-19 to establish a common frame of reference in the drawings. The z-axis may be parallel to the gravitational axis, the y-axis may be a longitudinal axis, and the x-axis may be a lateral axis. However, the axes may have other suitable orientations, in other examples.

Further in some examples, any of the foot peg systems described herein may be included in a kit that enables customization of the system to match a rider's inclinations and riding environment. The kit may include a frame mount and threaded spindle and associated hardware. The kit may further include multiple foot platforms and/or elastomeric stops. The foot platforms may have different profiles (e.g., thicknesses and/or surface areas) and the elastomeric stops may have different hardnesses. In this way, the customer can tune the foot peg assembly to fit their preferences, weight, body proportions, and riding environment, if wanted.

FIG. 2 shows an assembled view of the foot peg system 100 with the foot platform 120 that is rotationally coupled to the frame mount 102. Further, the elastomeric stop 146 is coupled to the frame mount 102 via the mounting device 112 and the spacer 150 may be positioned between the frame mount and the elastomeric stop. The mounting device 112 may provide a desired amount of compression to the elastomeric stop to prevent any substantial rotation of the stop. The mounting device 112 may include a head with a tool interface (e.g., a polygonal outer surface, a polygonal recess, a multi-point recess, and the like) that allows the stop to be compressed when installed. As shown, the elastomeric stop 146 is positioned underneath the foot platform 120, to avoid unwanted interaction between the stop and a rider's foot. Further, the foot platform 120 may include a cut-out 200 at an inboard side in which a portion of the frame mount 102 resides. The compactness of the foot platform assembly is consequently increased, if wanted. A top surface 202 of the mount 102 may be position at the same height of or below a top side 204 of the foot platform 120 to prevent the mount from interfering with the rider's foot placement on the platform.

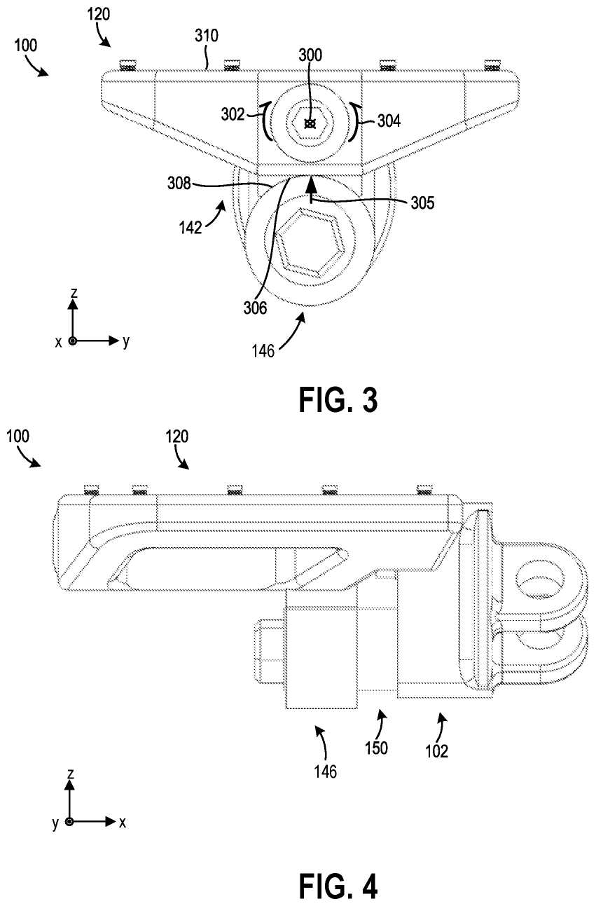

FIG. 3 shows a side view of the foot peg system 100 with the foot platform 120, the elastomeric stop 146, and the frame mount 102. As previously discussed, the foot platform 120 is designed to rotate about a rotational axis 300 in a clockwise direction 302 and a counterclockwise direction 304. As illustrated, a surface 306 on an underside 142 of the foot platform 120 may be in face sharing contact with an outer surface 308 of the elastomeric stop 146. The surface may therefore be shaped in an arc similar to the outer surface of the elastomeric stop. In one specific example, the elastomeric stop 146 may be pre-compressed during installation which allows the stop to exert a preload force 305 on the surface 306 of the platform 120. In such an example, the profile of the surface 306 may vary from the outer surface 308 of the elastomeric stop 146 when it is uncompressed.

The interaction between the elastomeric stop 146 and the underside of the foot platform 120 allows the stop to resist rotation of the platform by a desired amount as well as limit the rotation of the platform within a targeted range, as indicated above. The friction between the surfaces 306 and 308 facilitates the abovementioned rotational kinematics. In this way, the foot platform may rotate to reduce stress on the rider's ankles while providing support through its rotational travel to permit the rider to balance on the vehicle and perform handling inputs.

The foot platform 120 is shown in a neutral position in FIG. 3. In the neutral position a top surface 310 of the platform may be parallel to a horizontal plane or axis. Alternatively, the foot platform's neutral position may be arranged at an angle with regard to horizontal axis. For instance, the neutral position may be 5, 4, or 3 degrees from horizontal in a clockwise or counterclockwise direction. The neutral position may be chosen based on consumer needs, the vehicle's intended riding environment, and the like.

FIG. 4 shows another side view of the foot peg system 100 with the foot platform 120, the elastomeric stop 146, and the frame mount 102. The spacer 150 is shown axially interposed by the elastomeric stop 146 and the frame mount 102. The spacer permits the elastomeric stop 146 to be arranged at a desired position below the foot platform 120.

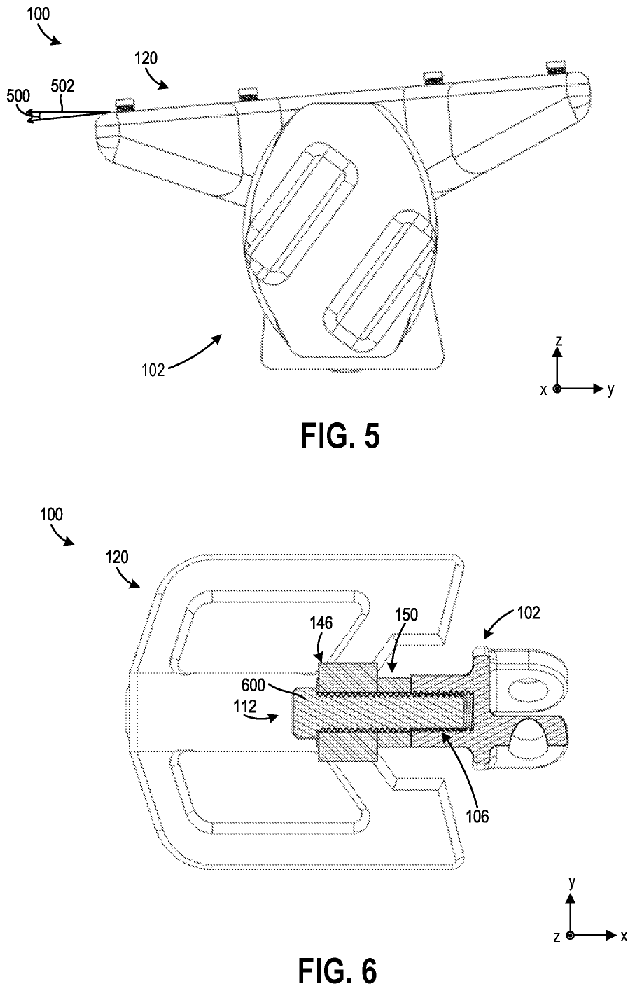

FIG. 5 depicts a side view of the foot peg system 100 with the foot platform 120 and the frame mount 102. The foot platform 120 is shown arranged at an angle 500 in relation to a horizontal axis 502. As indicated above, as the platform moves through its rotational range, the elastomeric stop may decrease the platform's rotational velocity. In this way, a balance may be struck between platform articulation and support that the platform provides to a rider's foot.

FIG. 6 shows a cross-sectional view of the foot peg system 100 with the foot platform 120, frame mount 102, elastomeric stop 146, spacer 150, and stop mounting device 112. The cutting plane for the cross-section depicted in FIG. 6 extends through a central axis of the stop mounting device 112. The mounting device 112 is shown threadingly engaged with the opening 106 in the frame mount. As shown, a head 600 of the mounting device 112 is in contact with the elastomeric stop 146.

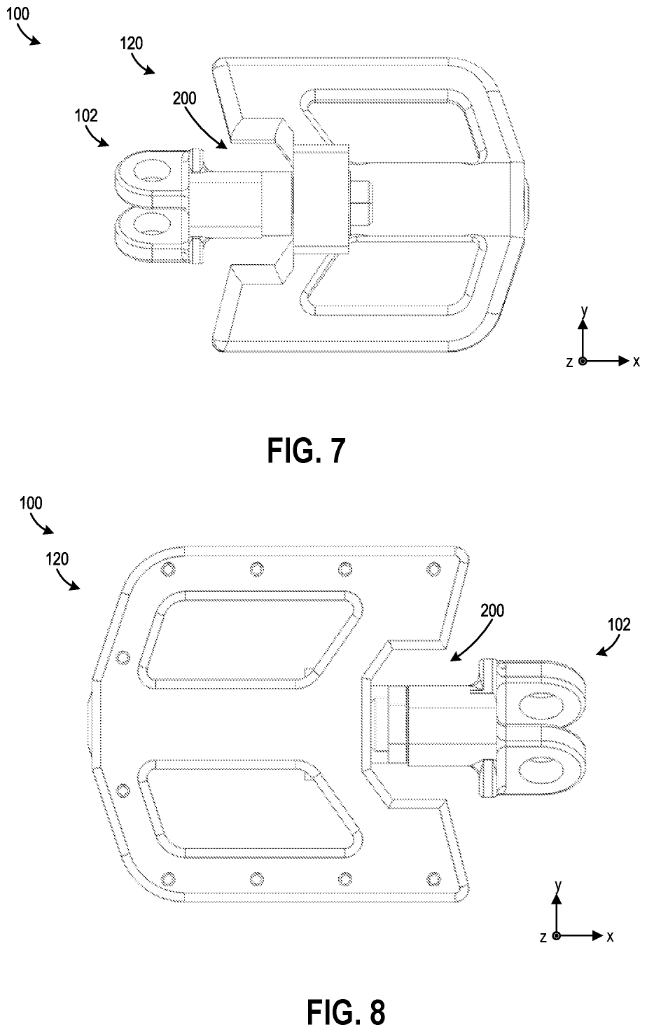

FIGS. 7 and 8 show a bottom and a top view, respectively, of the foot peg system 100 with the foot platform 120 and the frame mount 102. The recess 200 in the foot platform 120 is again illustrated.

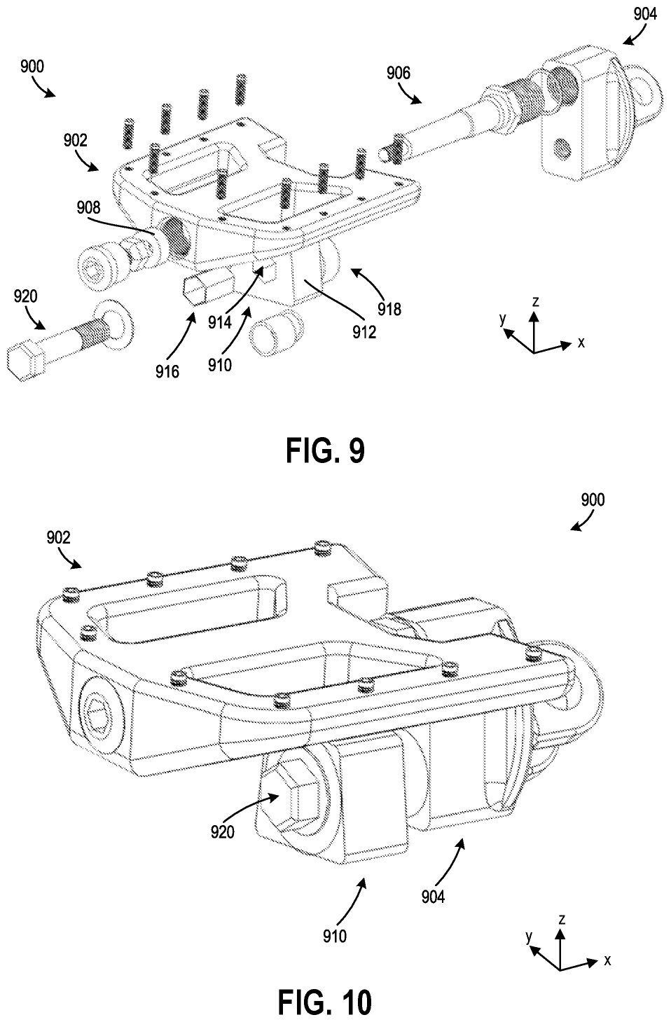

FIG. 9 shows a second example of a foot peg system 900. The foot peg system 900 again includes a foot platform 902, a frame mount 904, and a spindle 906. These components may share similar structural and/or functional features with the components in the foot peg system 100, depicted in FIGS. 1-8. For concision, redundant description is therefore forgone. A bearing 908 that may be mounted within the opening in the foot platform 902 are illustrated in FIG. 9.

The foot peg system 900 again includes an elastomeric stop 910. However, the stop 910, shown in FIG. 9 has an outer surface 912 with a polygonal contour. To elaborate, the outer surface 912 may include four sides which each have a different angular arrangement in relation to a horizontal axis. In this way, the neutral position of the foot platform 902 may be varied depending on the position in which the stop 910 is installed. For instance, one of the angular faces of the stop may allow the platform to have a neutral position that is 5 degrees as measured from a horizontal axis while another angular face of the stop may permit the platform to have neutral position that is 3 degrees from horizontal. Designing a stop in this manner permits the foot platform's neutral position to be quickly and efficiently adjusted. In this way, the foot peg system adaptability may be expanded.

The elastomeric stop 910 may further include an opening 914 that has a polygonal shape (e.g., a square shape, hexagonal shape, octagonal shape, an oval shape, etc.). A sleeve 916 may be contoured to mate with the opening 914. As such, the sleeve may have a square shape, hexagonal shape, octagonal shape, an oval shape, etc. Consequently, the elastomeric stop 910 may be mounted at a desired orientation due to the polygonal contour of the central opening 914 and the sleeve 916. The foot peg system 900 may again include a spacer 918 and a stop mounting device 920 that threads into the frame mount 904.

FIG. 10 shows a perspective view of the foot peg system 900 with the foot platform 902, the elastomeric stop 910, and the frame mount 904. The different faces of the elastomeric stop 910 are more clearly shown in FIG. 10. Further, the stop mounting device 920 may again provide a compressive force against the elastomeric stop 910 when the foot peg is assembled.

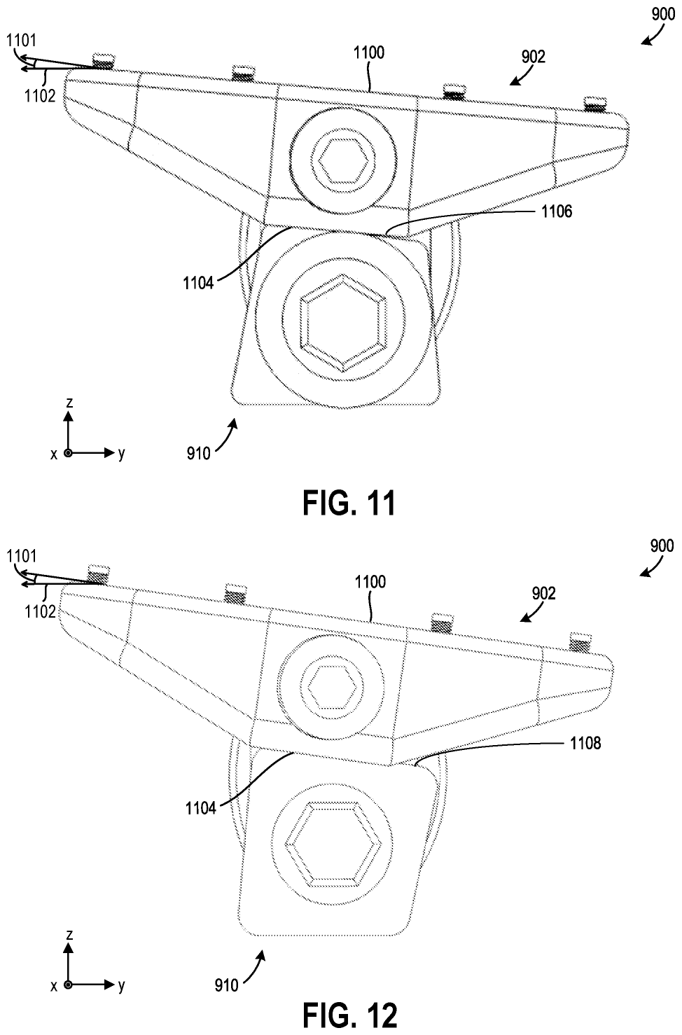

FIGS. 11-14 show the foot peg system 900 with the foot platform 902 with a top surface 1100 arranged at different angles 1101 with regard to a horizontal axis 1102. FIGS. 11, 12, and 13 specifically show the top surface 1100 arranged at angles greater than zero degrees in the neutral position while FIG. 14 shows the top surface aligned with the horizontal axis in the neutral position. To achieve these different angular positions, the elastomeric stop 910 is positioned in different orientations where outer faces 1106, 1108, 1110, 1112 of the elastomeric stop are in face sharing contact with a lower surface 1104 of the foot platform 902. Further, the face 1110 is shown forming an angle 1103 with a horizontal axis. The other faces may similarly form angles with a horizontal axis when oriented as the uppermost face. These angles may dictate the angle of the foot platform. The angles may be between 0 degrees and 15 degrees, in one use-case example. For instance, one face may form a 0 degree angle with the horizontal axis, another face may form a 5 degree angle with the horizontal axis, another face may form an 8 degree angle with the horizontal axis, etc.

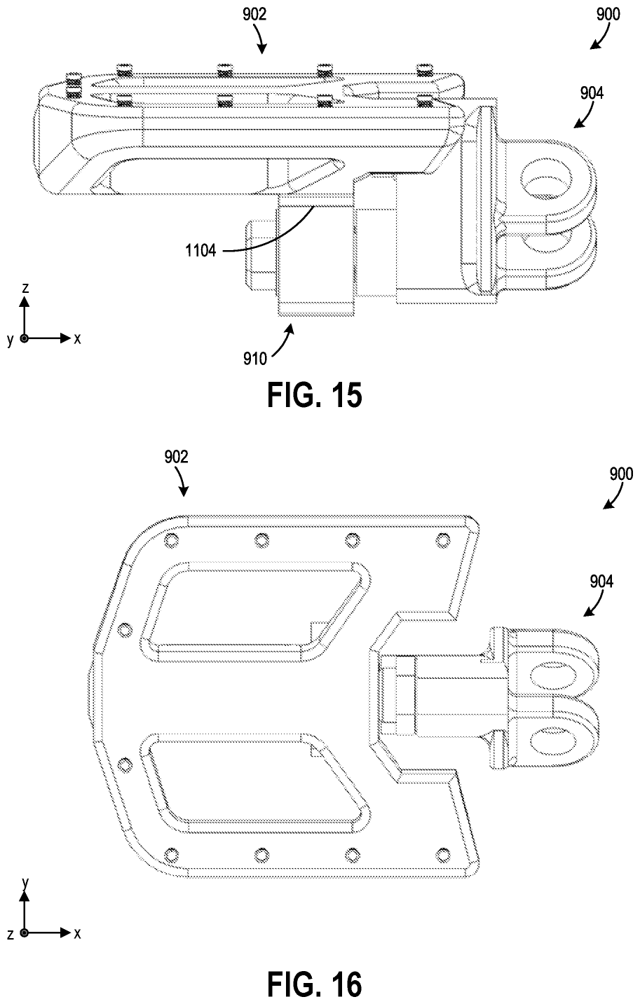

FIGS. 15 and 16 show a side view and a top view of the foot peg system 900, respectively, with the foot platform 902, and the frame mount 904. FIG. 15 specifically illustrates the elastomeric stop 910 in contact with the lower surface 1104 of the foot platform.

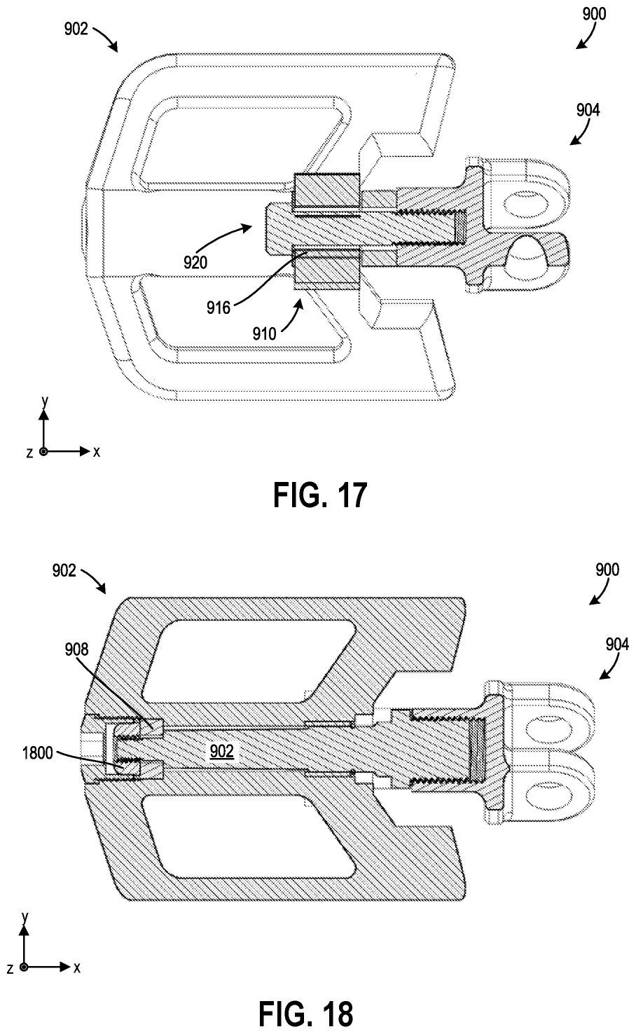

FIGS. 17-18 show cross-sectional illustrations of the foot peg system 900 with the foot platform 902, and the frame mount 904. The cutting plane for FIG. 17 extends through the central axis of the mounting device 920 and the cutting plane for FIG. 18 extends through the central axis of the spindle 906. FIG. 17 in particular depicts the mounting device 920 extending through the central opening of the sleeve 916 that is mated with the elastomeric stop 910 and threads into the frame mount 904. FIG. 18 shows the bearing 908 mounted in the foot platform 902 and the spindle 906 threaded into the frame mount 904 and a nut 1800 threaded on the outboard side of the spindle.

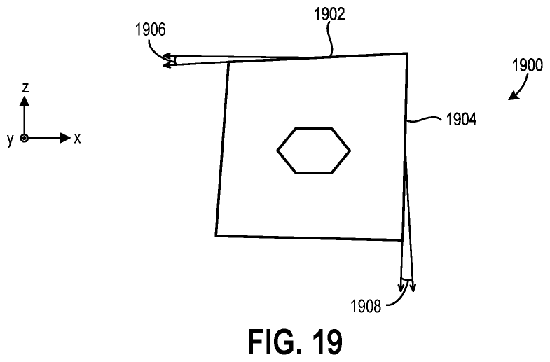

FIG. 19 shows another embodiment of an elastomeric stop 1900. The elastomeric stop again includes faces 1902, 1904 that form different angles 1906, 1908, respectively with horizontal and vertical axes. The angles 1906, 1908 may be 0 degrees and 4 degrees, in one use-case example. In another use-case example, the angles 1906, 1908 may be 5 degrees and 9 degrees. In yet another use-case example, the angles 1906, 1908 may be 10 degrees and 14 degrees. However, numerous angles have been envisioned and may be selected based on the expected riding environment of the foot peg, rider biomechanics, and the like.

FIGS. 1-19 are depicted approximately to scale aside from the schematically depicted vehicle components in FIG. 1. However, in other embodiments, the components may have other relative sizes.

The elements shown in FIGS. 1-19 are arranged in different example positions. Features in the figures may be referred to as in direct contact with one another, offset from one another, above or below one another, spaced away from one another, positioned between one another, positioned adjacent (e.g., laterally adjacent, vertically adjacent, and the like) to one another, circumferential in relation to one another, and the like.

Different embodiments are described herein by way of example and are not intended to be limiting. As such, the embodiments set forth herein are descriptive and are not restrictive. One of ordinary skill in the art will understand that concepts disclosed herein may be diverge from the described form and these divergent concepts are nevertheless captured in the scope of the description.

The invention will be further articulated in the subsequent paragraphs. In one example, a foot peg system for a saddle vehicle is provided that includes a threaded spindle threadingly engaged with a frame mount; a foot platform rotationally coupled to the threaded spindle and including an upper side having a plurality of grip extensions; and an elastomeric stop positioned below a rotational axis of the threaded spindle adjacent to a lower side of the foot platform, coupled to the frame mount, and designed to constrain rotation of the foot platform.

In another example, a foot peg kit for a saddle vehicle is provided that includes a threaded spindle configured to threadingly engaged with a frame mount; a first foot platform configured to rotationally couple to the threaded spindle and including an upper side that has a set of grip pins; a first elastomeric stop configured to: removably attach to an outboard side of the frame mount below the first foot platform; and constrain rotation of the first foot platform; and a second elastomeric stop configured to: removably attach to the outboard side of the frame mount; and constrain rotation of the first foot platform; wherein the first and second elastomeric stops have varied compliance.

In any of the examples or combinations thereof, the elastomeric stop may have an outer surface that is in face sharing contact with a surface on the lower side of the foot platform.

In any of the examples or combinations thereof, the outer surface may be planar.

In any of the examples or combinations thereof, the outer surface may be rounded.

In any of the examples or combinations thereof, the foot peg system may further include a stop mounting device extending through a central opening of the elastomeric stop and removably coupled to the frame mount.

In any of the examples or combinations thereof, an outer radial cross-section of the elastomeric stop may have a polygonal shape.

In any of the examples or combinations thereof, an opening in the elastomeric stop may have a polygonal shape and the foot peg system may further include a sleeve profiled to mate with the opening in the elastomeric stop and receive a stop mounting device that is removably coupled to the frame mount.

In any of the examples or combinations thereof, the foot platform may include a body constructed out of a polymer.

In any of the examples or combinations thereof, the polymer may include polyethylene.

In any of the examples or combinations thereof, the elastomeric stop may be constructed out of polyurethane.

In any of the examples or combinations thereof, the frame mount may include a threaded interface threadingly engaged with the threaded spindle and an opening designed to attached to a frame interface in the saddle vehicle via a pin.

In any of the examples or combinations thereof, the foot peg kit may further comprise a second foot platform configured to rotationally couple to the threaded spindle and including an upper side and wherein the upper side of the first foot platform has a different profile and/or size than the upper side of the second foot platform.

In any of the examples or combinations thereof, each of the first and second elastomeric stops may have a polygonal outer profile.

In any of the examples or combinations thereof, the frame mount may include a threaded interface that is threadingly engaged with the threaded spindle and an opening configured to attached to a frame interface in the saddle vehicle via a pin.

In any of the examples or combinations thereof, the first and second elastomeric stops may have a similar size and profile.

In any of the examples or combinations thereof, the polymer may be a nylon composite.

In any of the examples or combinations thereof, the elastomeric stop may be compressed and exert a preload force on the lower side of the foot platform.

In any of the examples or combinations thereof, the foot platform may include a surface on the lower side contoured to mate with the elastomeric stop.

The preceding claims provide combinations of features that are considered to be novel and non-obvious. The claims may recite “a first” element, “an” element, and the like and these claims are to be understood as including one or more of the corresponding element. Further, these claims are to be interpreted as neither necessitating nor prohibiting two or more of the elements. The claimed features, components, elements, etc. described herein may be arranged in alternate combinations by way of amendment. These claims of differing scope in relation to the original claims, lie within the subject matter of the current disclosure.

1. A foot peg system for a saddle vehicle, comprising:
a threaded spindle threadingly engaged with a frame mount;
a foot platform rotationally coupled to the threaded spindle and including an upper side having a plurality of grip extensions; and
an elastomeric stop positioned below a rotational axis of the threaded spindle adjacent to a lower side of the foot platform, coupled to the frame mount, and designed to constrain rotation of the foot platform.

2. The foot peg system of claim 1, wherein the elastomeric stop has an outer surface that is in face sharing contact with a surface on the lower side of the foot platform.

3. The foot peg system of claim 2, wherein the outer surface is planar.

4. The foot peg system of claim 2, wherein the outer surface is rounded.

5. The foot peg system of claim 2, further comprising a stop mounting device extending through a central opening of the elastomeric stop and removably coupled to the frame mount.

6. The foot peg system of claim 1, wherein an outer radial cross-section of the elastomeric stop has a polygonal shape.

7. The foot peg system of claim 6, wherein an opening in the elastomeric stop has a polygonal shape and the foot peg system further comprises a sleeve profiled to mate with the opening in the elastomeric stop and receive a stop mounting device that is removably coupled to the frame mount.

8. The foot peg system of claim 1, wherein the foot platform comprises a body constructed out of a polymer.

9. The foot peg system of claim 8, wherein the polymer includes polyethylene.

10. The foot peg system of claim 1, wherein the elastomeric stop is constructed out of polyurethane.

11. The foot peg system of claim 1, wherein the frame mount includes a threaded interface threadingly engaged with the threaded spindle and an opening designed to attached to a frame interface in the saddle vehicle via a pin.

12. A foot peg system for a saddle vehicle, comprising:
a threaded spindle threadingly engaged with a frame mount;
a foot platform rotationally coupled to the threaded spindle, including an upper side having a plurality of grip extensions, and constructed out of a polymer; and
an elastomeric stop positioned below a rotational axis of the threaded spindle, in face sharing contact with a surface on a lower side of the foot platform, coupled to the frame mount, and constraining rotation of the foot platform with a range±45 degrees from neutral.

13. The foot peg system of claim 12, wherein the polymer is a nylon composite.

14. The foot peg system of claim 12, wherein the elastomeric stop is compressed and exerts a preload force on the lower side of the foot platform.

15. The foot peg system of claim 12, wherein the foot platform includes a surface on the lower side contoured to mate with the elastomeric stop.
